(19) United States
(12) Patent Application Publication
(10) Pub. No.: US 2003/0118709 A1
(43) Pub. Date: Jun. 26, 2003

(54) Flavor-enhancing agent for foods

(76) Inventor: Tomoyasu Nakamura, Osaka (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/203,705

(22) PCT Filed: Feb. 8, 2001
(86) PCT No.: PCT/JP01/00898

(30) Foreign Application Priority Data
Feb. 15, 2000 (JP) 2000-36465

(51) Int. Cl. A23L 1/22

(52) U.S. Cl. 426/534

(57) ABSTRACT

A Fe—Ni—Co based alloy being improved in proof stress and Young's modulus as indexes for the resistance to fall impact deformation while maintaining low thermal expansion properties for use in a completely flat mask of a press-formed type, which comprises, in mass %, 30 to 35% of Ni, 2 to 8% of Co and 0.01 to 0.5% of Mn, and further comprises one or more selected from among 0.01 to 0.8% of Nb, 0.01 to 0.8% of Ta and 0.01 to 0.8% of Hf in an total amount of 0.01 to 0.8%, the balance of the alloy being Fe and inevitable impurities; and a completely flat mask and a color cathode-ray tube using the Fe—Ni—Co based alloy. It is preferred that the contents of C, Si, P, S and N as impurities in the ally are controlled to 0.01% or less, 0.04% or less, 0.01% or less, 0.01% or less and 0.005% or less, respectively.

### TECHNICAL FIELD

The present invention relates to a flavor-enhancing agent containing a nontoxic salt of gluconic acid as an active ingredient, to a seasoning or a food to which the agent is added, and to a method for enhancing the flavor of the seasoning or food by using the agent.

### BACKGROUND ART

The taste of a food comprises sweetness, saltness, acidity, bitterness and flavor. A food with these elements balanced properly is evaluated as “delicious.” In addition, when two or more kinds of substances stimulating the sense of taste are mixed in a food, it is known that they take actions mutually on the taste of the food. These actions provide a synergistic effect, a contrast effect, a masking effect, a cancel effect (inhibitory action), etc. For example, when a nucleic-acid-based flavor substance is added to an amino-acid-based flavor substance, such as glutamic acid, it is known that a synergistic effect occurs wherein the obtained flavor is enhanced synergistically.

It has been found that gluconic acid is a substance that is present in a food as an acidifier and mixed with other acidic substances to provide excellent acidity. In addition, it is known that the gluconic acid is present in many fermented foods, such as brewed vinegar, wine, pickled vegetable and miso, and has an effect on the formation of the rich and full-flavored acidity of fermented foods. This is attained by the taste-forming characteristic of the gluconic acid used as an acidifier. Furthermore, gluconate, such as sodium gluconate or potassium gluconate, that is, an organic acid salt of the gluconic acid, provides a slight salty taste in itself, but is not a flavor substance.

In these days, among elements constituting taste, substances providing flavors are highly valued as substances being present in foods. In food design for pleasant taste, the utilization of flavor substances has become an important task. A substance that provides no flavor in itself but enhances the flavors of flavor substances mixed therewith has not existed up to now. Hence, such a substance is expected as one of food taste designing means.

### DISCLOSURE OF THE INVENTION

The inventors of the present invention have found that, although gluconate, such as sodium gluconate and potassium gluconate, is not a flavor substance in itself, when the gluconate is mixed with a flavor seasoning and a flavor substance in a processed food, the gluconate has an effect of enhancing their flavors. As a result, the inventors have found a flavor-enhancing agent containing a nontoxic salt of gluconic acid as an active ingredient, a seasoning or a food to which the agent is added, and a method for enhancing the flavor of the seasoning or food by using the agent.

The nontoxic salt of gluconic acid may include, for example, an alkaline metal salt of gluconic acid, such as sodium gluconate and potassium gluconate, and an alkaline earth metal salt of gluconic acid, such as calcium gluconate and magnesium gluconate. The particularly preferable salts among these are sodium gluconate and potassium gluconate.

The flavor-enhancing agent of the present invention is used in the forms of preparations, such as powder, granule, tablet and solution prepared by the usual manner, containing the nontoxic salt of gluconic acid independently as it is or in appropriate admixture with various additives or solvents. The content of the nontoxic salt of gluconic acid in these preparations is determined as desired.

The additives for the preparations in the forms of powder, granule and tablet may include dietary fiber such as apple fiber, corn fiber, alginic acid, carrot powder, pectin, seaweed polysaccharide and carboxymethyl cellulose; excipients such as lactose and starch; sweeteners such as sucrose, maltose, fructose, sorbitol, mannitol, stevioside and aspartame; nutritional supplements such as vitamin, mineral, milk powder and meat extract; perfume; binders such as gum arabic powder, polyvinyl pyrrolidine and hydroxypropyl cellulose; lubricants such as magnesium stearate, calcium stearate and talc. One or two or more kinds of these are selected and used as necessary.

A solution is generally obtained by dissolving or suspending the nontoxic salt of gluconic acid in a solvent that can dissolve the salt. As such a solvent, water is used most frequently.

In addition, the present invention provides seasonings and foods to which the nontoxic salt of gluconic acid is added so as to be contained. The seasonings may herein include broths and extracts from natural flavor materials such as dried-bonito broth, dried-mackerel broth, boiled-dried fish broth, kelp broth, chicken extract, pork bone extract, consomme and chicken soup; amino acids such as sodium glutamate, glycin, alanine, sodium aspartate, arginine, theanine and valine; nucleic acids such as disodium 5′-inosinate, disodium 5′-uridylate, disodium 5′-guanylate, disodium 5′-cytidylate, calcium 5′-ribonucleotide and disodium 5′-ribonucleotide; organic acids such as succinic acid, monosodium succinate and disodium succinate; seasonings obtained by using these broths, extracts, amino acids, nucleic acids and the organic acids as main materials independently or in mixture at desired mixture ratios and by subjecting them to processes such as concentration, drying and granulation; and the like. The kinds of seasonings, the flavors of which are enhanced, are not limited to those exemplified above.

The flavor-enhancing agent of the present invention is applicable to the enhancement of the flavors of various foods. Foods, the flavors of which are enhanced, may include packed cooked rice; instant noodle; instant curry; instant soup; soybean milk; red bean soup with rice cake (zenzai); vegetable juice; Japanese tea; oolong tea; black tea; coffee; cocoa; dried fish; fish cake products such as fish meat sausage and fish paste; canned fish; packed broiled fish such as broiled eel; packed boiled fish such as boiled tuna chunks; fermented fish products such as cuttlefish pickled in salt; salted products such as cod roe and salmon roe; smoked products such as smoked salmon; pickled products such as pickled mackerel; milk; yogurt; cheese; dip for roasted meat; grilled chicken; beef guts cooked in pot; ham; sausage; hamburger; eggs fried in layers; steamed egg custard; pot-steamed hotchpotch; miso soup; fermented soybeans (natto); pickled vegetable; sake; sparkling liquor; whiskey; distilled spirit (shochu); and wine. The kinds of foods, the flavors of which are enhanced, are not limited to those exemplified above. Not only the flavors of processed foods, but also the flavors of foods served at restaurants and the flavors of foods prepared at home can be enhanced by adding the flavor-enhancing agent.

The method for adding the flavor-enhancing agent of the present invention to a seasoning or a food, the flavor of which is enhanced, is not limited particularly. Hence, the method is carried out by mixing, scattering or spraying the agent to the seasoning, food or its materials at the time when the target seasoning is produced or when the target food is processed, cooked or eaten.

The amount of the flavor-enhancing agent added to a seasoning may be increased or decreased as necessary depending on the kind and intensity of the flavor of the seasoning to be enhanced. It is preferable that the effective amount of addition is determined as necessary by carrying out table tests. The ratio of the amount of addition of the flavor-enhancing agent with respect to the amount of extract or broth is generally 0.01 to 5.0%, preferably 0.1 to 1.0%, when the nontoxic salt of gluconic acid is used as the flavor-enhancing agent. As examples, as indicated in Examples described later, a sufficient effect can be obtained when the ratio of the amount of addition is 0.1 to 1.0% with respect to the amount of pork bone extract or dried-bonito broth. The ratio of the amount of addition to a dried seasoning in the form of powder, granule or the like is 1 to 1000 weight parts, preferably 1 to 300 weight parts, with respect to the 100 weight parts of the dried seasoning. As examples, as indicated in Examples described later, a sufficient effect can be obtained when the ratio of the amount of addition is 33 to 333 weight parts with respect to the amount of a mixture flavor seasoning (Hi—Me) (the ratio of the amount of addition is 0.1 to 1.0% with respect to the amount of a 0.3% solution); when the ratio of the amount of addition is 6 to 56 weight parts with respect to the amount of consomme (Consommenomoto) (the ratio of the amount of addition is 0.1 to 1.0% with respect to the amount of a 1.77% solution); and when the ratio of the amount of addition is 13 to 125 weight parts with respect to the amount of kelp broth (Kobudashinomoto) (the amount of addition is 0.1 to 1.0% with respect to the amount of a 0.8% solution).

The amount of the flavor-enhancing agent added to a food may be increased or decreased as necessary depending on the kind and intensity of the flavor of the food to be enhanced. It is preferable that the effective amount of addition is determined as necessary by carrying out table tests. The ratio of the amount of addition of the flavor-enhancing agent with respect to the amount of the food, the flavor of which is enhanced, is generally 0.01 to 3.0 wt %, preferably 0.01 to 1.0 wt %, when the nontoxic salt of gluconic acid is used as the flavor-enhancing agent. As examples, as indicated in Examples described later, a sufficient effect can be obtained when the ratio of the amount of addition is 0.06 wt % (0.15 g/250 g) with respect to the amount of noodle; when the ratio of the amount of addition is 0.15 wt % (0.15 g/100 g) with respect to the amount of fish meat sausage; when the ratio of the amount of addition is 0.33 wt % (0.1 g/30 g) with respect to the amount of cod roe; when the ratio of the amount of addition is 0.17 wt % (0.05 g/30 g) with respect to the amount of cheese; when the ratio of the amount of addition is 0.08 wt % (0.15 g/200 g) with respect to the amount of miso soup; and when the ratio of the amount of addition is 0.07 wt % (0.1 g/150 ml) with respect to the amount of sake.

### BEST MODE FOR CARRYING OUT THE INVENTION

Examples wherein gluconate was added to various kinds of seasonings or foods and examples wherein the flavor-enhancing effects on the seasonings or foods were evaluated are explained in Examples described below. However, the present invention is not limited to these Examples.

The flavor-enhancing effects were evaluated in accordance with the following method, unless otherwise specified.

Samples prepared by adding the flavor-enhancing agent were subjected to a sensory test. In the sensory test, the samples were evaluated by 10 expert panelists in accordance with the following standard. The result of the evaluation was indicated by the average of the evaluation values marked by all the panelists.

Evaluation Standard

−3: the flavor was weakened significantly.

−2: the flavor was weakened.

−1: the flavor was weakened slightly.

0: the flavor was unchanged.

+1: the flavor was enhanced slightly.

+2: the flavor was enhanced.

+3: the flavor was enhanced significantly.

### EXAMPLE 1

Flavor-Enhancing Effects on Extracts (Broths) of Natural Flavor Materials and Commercially Available Seasonings

(1) Chicken Extract

Chicken bones (400 g) were washed and boiled. After hot water was discarded, the chicken bones were washed again. The chicken bones were put into water (1,500 ml) together with ginger (20 g) and one half green onion, and they were cooked for three hours without boiling while removing harshness. After cooling, the fat on the surface was removed, and pureeing was carried out to prepare a test extract. Sodium gluconate was added to the test extract so as to have a content of 0 to 1%, thereby preparing samples. Each sample was subjected to a sensory test, and its flavor-enhancing effect was evaluated.

TABLE 1

| | | | | | |
|---|---|---|---|---|---|
| Amount of sodium | 0% | 0.1% | 0.3% | 0.5% | 1.0% |
| gluconate | | | | | |
| Result of | 0 | 0.3 | 0.8 | 1.3 | 1.6 |
| evaluation | | | | | |

As indicated in the table, the flavor of the chicken extract was able to be enhanced by adding sodium gluconate to the chicken extract.

(2) Pork Bone Extract

Pork bones (400 g) were washed and boiled. After hot water was discarded, the pork bones were washed again. The pork bones were put into water (1,500 ml) together with ginger (20 g) and one half green onion, and they were cooked for three hours without boiling while removing harshness. After cooling, the fat on the surface was removed, and pureeing was carried out to prepare a test extract. Sodium gluconate was added to the test extract so as to have a content of 0 to 1%, thereby preparing samples. Each sample was subjected to a sensory test, and its flavor-enhancing effect was evaluated.

TABLE 2

| | | | | | |
|---|---|---|---|---|---|
| Amount of sodium | 0% | 0.1% | 0.3% | 0.5% | 1.0% |
| gluconate | | | | | |
| Result of | 0 | 0.4 | 0.7 | 1.4 | 1.7 |
| evaluation | | | | | |

As indicated in the table, the flavor of the pork bone extract was able to be enhanced by adding sodium gluconate to the pork bone extract.

(3) Dried-Bonito Broth

Dried bonito shavings (Tokuichiban Hanakatsuo) (30 g) sold by Yamaki Co., Ltd. was put into water (1000 ml) and boiled for 15 minutes over a medium flame. This was filtered through cotton gauze and then cooled to prepare a test extract. Sodium gluconate was added to the test extract so as to have a content of 0 to 1%, thereby preparing samples. Each sample was subjected to a sensory test, and its flavor-enhancing effect was evaluated.

TABLE 3

| | | | | | |
|---|---|---|---|---|---|
| Amount of sodium | 0% | 0.1% | 0.3% | 0.5% | 1.0% |
| gluconate | | | | | |
| Result of | 0 | 1.4 | 2.3 | 2.6 | 1.8 |
| evaluation | | | | | |

As indicated in the table, the flavor of the dried-bonito broth was able to be enhanced by adding sodium gluconate to the dried-bonito extract.

(4) Dried-Mackerel Broth

Dried mackerel shavings (Umamidashi) (20 g) sold by Suruga Foods Co., Ltd. was put into water (600 ml) and boiled for 15 minutes over a medium flame. This was filtered through cotton gauze and then cooled to prepare a test extract. Sodium gluconate was added to the test extract so as to have a content of 0 to 1%, thereby preparing samples. Each sample was subjected to a sensory test, and its flavor-enhancing effect was evaluated.

TABLE 4

| | | | | | |
|---|---|---|---|---|---|
| Amount of sodium | 0% | 0.1% | 0.3% | 0.5% | 1.0% |
| gluconate | | | | | |
| Result of | 0 | 1.3 | 1.8 | 2.6 | 2.7 |
| evaluation | | | | | |

As indicated in the table, the flavor of the dried-mackerel broth was able to be enhanced by adding sodium gluconate to the dried-mackerel extract.

(5) Boiled-Dried Fish Broth,

Boiled-dried fish (with heads and guts removed) (25 g) was put into water (800 ml) and boiled for three minutes. This was filtered through cotton gauze and then cooled to prepare a test extract. Sodium gluconate was added to the test extract so as to have a content of 0 to 1%, thereby preparing samples. Each sample was subjected to a sensory test, and its flavor-enhancing effect was evaluated.

TABLE 5

| | | | | | |
|---|---|---|---|---|---|
| Amount of sodium | 0% | 0.1% | 0.3% | 0.5% | 1.0% |
| gluconate | | | | | |
| Result of | 0 | 1.1 | 1.6 | 2.3 | 1.2 |
| evaluation | | | | | |

As indicated in the table, the flavor of the boiled-dried fish broth was able to be enhanced by adding sodium gluconate to the boiled-dried fish extract.

(6) Consomme

Consomme (“Consommenomoto” produced by Ajinomoto Co., Inc.) (10.6 g) was put into water (600 ml) and boiled and dissolved (a 1.77% solution). After cooling, sodium gluconate was added to the solution so as to have a content of 0 to 1%, thereby preparing samples. Each sample was subjected to a sensory test, and its flavor-enhancing effect was evaluated.

TABLE 6

| | | | | | |
|---|---|---|---|---|---|
| Amount of sodium | 0% | 0.1% | 0.3% | 0.5% | 1.0% |
| gluconate | | | | | |
| Result of | 0 | 0.2 | 0.5 | 1.2 | 1.4 |
| evaluation | | | | | |

As indicated in the table, the flavor of the consomme was able to be enhanced by adding sodium gluconate to the consomme.

(7) Chicken Soup

Chicken soup (“Marutorigara Soup” produced by Ajinomoto Co., Inc.) (4 g) was put into water (600 ml) and boiled and dissolved (a 0.67% solution). After cooling, sodium gluconate was added to the solution so as to have a content of 0 to 1%, thereby preparing samples. Each sample was subjected to a sensory test, and its flavor-enhancing effect was evaluated.

TABLE 7

| | | | | | |
|---|---|---|---|---|---|
| Amount of sodium | 0% | 0.1% | 0.3% | 0.5% | 1.0% |
| gluconate | | | | | |
| Result of | 0 | 0.8 | 1.1 | 1.4 | 1.7 |
| evaluation | | | | | |

As indicated in the table, the flavor of the chicken soup was able to be enhanced by adding sodium gluconate to the chicken soup.

(8) Bonito Broth

Bonito broth (“Hondashi Katsuobushi” produced by Ajinomoto Co., Inc.) (4 g) was put into water (600 ml) and boiled and dissolved (a 0.67% solution). After cooling, sodium gluconate was added to the solution so as to have a content of 0 to 1%, thereby preparing samples. Each sample was subjected to a sensory test, and its flavor-enhancing effect was evaluated.

TABLE 8

| | | | | | |
|---|---|---|---|---|---|
| Amount of sodium | 0% | 0.1% | 0.3% | 0.5% | 1.0% |
| gluconate | | | | | |
| Result of | 0 | 0.9 | 1.1 | 1.5 | 1.6 |
| evaluation | | | | | |

As indicated in the table, the flavor of the bonito broth was able to be enhanced by adding sodium gluconate to the bonito broth.

(9) Kelp Broth

Kelp broth (“Kobudashinomoto” produced by Shimaya Co., Ltd.) (8 g) was put into water (1000 ml) and boiled and dissolved (a 0.8% solution). After cooling, sodium gluconate was added to the solution so as to have a content of 0 to 1%, thereby preparing samples. Each sample was subjected to a sensory test, and its flavor-enhancing effect was evaluated.

TABLE 9

| | | | | | |
|---|---|---|---|---|---|
| Amount of sodium | 0% | 0.1% | 0.3% | 0.5% | 1.0% |
| gluconate | | | | | |
| Result of | 0 | 0.8 | 1.2 | 1.5 | 1.7 |
| evaluation | | | | | |

As indicated in the table, the flavor of the kelp broth was able to be enhanced by adding sodium gluconate to the kelp broth.

### EXAMPLE 2

Flavor-Enhancing Effects on Flavor Substances and Seasonings Containing the Flavor Substances

(1) Sodium Glutamate

Sodium glutamate and sodium gluconate were mixed at various mixture ratios and dissolved in water, thereby preparing samples. Each sample was subjected to a sensory test, and its flavor-enhancing effect was evaluated.

TABLE 10

| Concentration* of | | 0% | 0.05% | 0.1% | 0.3% | 0.5% |
|---|---|---|---|---|---|---|
| sodium gluconate | | | | | | |
| Concentration* | 0.05% | 0 | 0.2 | 0.4 | 0.7 | 1.2 |
| of sodium | 0.1% | 0 | 1.2 | 1.4 | 1.8 | 1.9 |
| glutamate | 0.2% | 0 | 1.8 | 1.8 | 1.9 | 2.1 |

*Concentration when dissolved in water

As indicated in the table, the flavor of sodium glutamate was able to be enhanced by adding sodium gluconate to sodium glutamate.

(2) Glycin

Glycin and sodium gluconate were mixed at various mixture ratios and dissolved in water, thereby preparing samples. Each sample was subjected to a sensory test, and its flavor-enhancing effect was evaluated.

TABLE 11

| Concentration* of | | 0% | 0.05% | 0.1% | 0.3% | 0.5% |
|---|---|---|---|---|---|---|
| sodium gluconate | | | | | | |
| Concentration* | 0.3% | 0 | 0.2 | 0.2 | 0.5 | 0.6 |
| of glycin | 0.5% | 0 | 0.4 | 0.6 | 1.9 | 2.0 |

*Concentration when dissolved in water

As indicated in the table, the flavor of glycin was able to be enhanced by adding sodium gluconate to glycin.

(3) Disodium Succinate

Disodium succinate and sodium gluconate were mixed at various mixture ratios and dissolved in water, thereby preparing samples. Each sample was subjected to a sensory test, and its flavor-enhancing effect was evaluated.

TABLE 12

| Concentration* of | | 0% | 0.05% | 0.1% | 0.3% | 0.5% |
|---|---|---|---|---|---|---|
| sodium gluconate | | | | | | |
| Concentration* | 0.01% | 0 | 0.6 | 0.8 | 1.7 | 1.7 |
| of disodium | 0.05% | 0 | 0.4 | 0.5 | 1.8 | 2.0 |
| succinate | 0.1% | 0 | 1.1 | 1.2 | 1.8 | 1.9 |

*Concentration when dissolved in water

As indicated in the table, the flavor of disodium succinate was able to be enhanced by adding sodium gluconate to disodium succinate.

(4) Mixture Seasoning 1

Mixture seasoning 1 wherein sodium glutamate and disodium 5′-ribonucleotide were mixed at a ratio of 98:2 was further mixed with sodium gluconate at various mixture ratios and dissolved in water, thereby preparing samples. Each sample was subjected to a sensory test, and its flavor-enhancing effect was evaluated.

TABLE 13

| Concentration* of | | 0% | 0.05% | 0.1% | 0.3% | 0.5% |
|---|---|---|---|---|---|---|
| sodium gluconate | | | | | | |
| Concentration* | 0.05% | 0 | 0.8 | 0.8 | 1.6 | 2.0 |
| of Mixture | 0.1% | 0 | 1.5 | 1.7 | 2.3 | 2.3 |
| seasoning 1 | 0.2% | 0 | 0.4 | 0.5 | 2.1 | 2.3 |

*Concentration when dissolved in water

As indicated in the table, the flavor of Mixture seasoning 1 was able to be enhanced by adding sodium gluconate to Mixture seasoning 1.

(5) Mixture Seasoning 2

To a 0.3% solution of Mixture seasoning 2 (“Hi-Me” produced by Ajinomoto Co., Inc., a commercially available mixture seasoning) wherein sodium glutamate, disodium 5′-ribonucleotide and disodium succinate were contained at a mixture ratio of 90:9:1, sodium gluconate was added so as to have a content of 0 to 1%, thereby preparing samples. Each sample was subjected to a sensory test, and its flavor-enhancing effect was evaluated.

TABLE 14

| | | | | | |
|---|---|---|---|---|---|
| Amount of sodium | 0% | 0.1% | 0.3% | 0.5% | 1.0% |
| gluconate | | | | | |
| Result of | 0 | 1.0 | 1.2 | 1.9 | 2.0 |
| evaluation | | | | | |

As indicated in the table, the flavor of Mixture seasoning 2 was able to be enhanced by adding sodium gluconate to Mixture seasoning 2.

### EXAMPLE 3

Flavor-Enhancing Effects on Commercially Available Processed Foods

With 0.05 g of sodium gluconate used as one unit, one to three units (0.05 g, 0.1 g and 0.15 g) thereof were sprinkled and added to various kinds of commercially available processed foods, thereby preparing samples. Each sample was subjected to a sensory test, and its flavor-enhancing effect was evaluated.

TABLE 15

| | | | Amount of | |
|---|---|---|---|---|
| | | Manufacturer | sodium | Evalu- |
| Food name | Trade name | (seller) | gluconate | ation |
| Instant | Akaikitsune | Toyo Suisan | 0.15 g/250 g | +1.7 |
| noodle | | | | |
| Instant | Cup Noodle | Nissin Food | 0.1 g/180 g | +0.9 |
| ramen | | Products | | |
| Instant | Potage | Ajinomoto | 0.15 g/200 g | +1.8 |
| soup | | | | |
| Black tea | Gogonokocha | Kirin | 0.15 g/250 ml | +1.0 |
| | | Beverage | | |
| Cocoa | Harsheys | Snow Brand | 0.1 g/200 ml | +0.9 |
| | Cocoa Drink | Milk | | |
| Dried fish | Aji | Ito-Yokado | 0.15 g/80 g | +1.7 |
| Fish cake | Gyoniku | Maruha | 0.15 g/100 g | +1.3 |
| product | sausage | | | |
| Canned fish | Sabamizuni | Maruha | 0.1 g/100 g | +1.2 |
| Packed | Unagino- | Ito-Yokado | 0.15 g/100 g | +0.7 |
| cooked fish | kabayaki | | | |
| Fermented | Ikano- | Taiyo Sangyo | 0.15 g/50 g | +0.8 |
| fish food | shiokara | | | |
| Salted | Tarako | Ito-Yokado | 0.1 g/30 g | +1.2 |
| product | | | | |
| Smoked | Sake Kunsei | Ito-Yokado | 0.15 g/100 g | +0.7 |
| product | | | | |
| Pickled | Shimesaba | Kuji Gyokyo | 0.15 g/100 g | +1.4 |
| product | | | | |
| Milk (non- | Tokachi Milk | Meiji Milk | 0.1 g/180 g | +0.7 |
| adjusted) | | | | |
| Cheese | Blue | Nippon My | 0.05 g/30 g | +1.4 |
| | (Stilton) | Cellar | | |
| Roasted | Ebara- | Ebara Foods | 0.15 g/100 g | +1.0 |
| meat (beef) | yakinikuno- | | | |
| | tare | | | |
| Grilled | Butareba | Ito-Yokado | 0.1 g/30 g | +1.3 |
| chicken | Shioyaki | | | |
| Beef guts | Kotetsuchan | Itoham Foods | 0.1 g/200 g | +1.2 |
| Sausage | Gurumewiener | Itoham Foods | 0.15 g/50 g | +1.0 |
| Egg custard | Tamagodofu | Kibun Foods | 0.15 g/120 g | +1.3 |
| Miso soup | Sokuseki | Asahimatsu | 0.15 g/200 g | +1.2 |
| | Misoshiru | Foods | | |
| Pickle | Takuan | Yamaden | 0.1 g/20 g | +0.7 |
| Sake | Dekabin Mild | Kikumasamune | 0.1 g/150 ml | +1.9 |
| Whiskey | Red | Suntory | 0.1 g/100 ml | +0.8 |

As indicated in the table, the flavor of each processed food was able to be enhanced by adding sodium gluconate to the processed food.

### INDUSTRIAL APPLICABILITY

The flavor-enhancing agent containing a nontoxic salt of gluconic acid in accordance with the present invention has an effect of enhancing the flavor of a seasoning or a food.

1. A flavor-enhancing agent containing a nontoxic salt of gluconic acid as an active ingredient.

2. A flavor-enhancing agent in accordance with claim 1, wherein said nontoxic salt of gluconic acid is an alkaline metal salt or an alkaline earth metal salt of gluconic acid.

3. A seasoning to which an amount of-said flavor-enhancing agent in accordance with claim 1, sufficient to enhance the flavor of said seasoning, is added.

4. A seasoning in accordance with claim 3, wherein said seasoning is chicken extract, pork bone extract, dried-bonito broth, boiled-dried fish broth, kelp broth, consomme, chicken soup, sodium glutamate, glycin, disodium succinate, disodium 5′-ribonucleotide or a mixture of these.

5. A method for enhancing the unique flavor of a seasoning by adding said flavor-enhancing agent in accordance with claim 1 to said seasoning.

6. A food to which an amount of said seasoning in accordance with claim 3, sufficient to enhance the flavor of said food, is added.

7. A food to which an amount of said flavor-enhancing agent in accordance with claim 1, sufficient to enhance the flavor of said food, is added.

8. A food in accordance with claim 7, wherein said food is packed cooked rice, instant noodle, instant curry, instant soup, soybean milk, red bean soup with rice cake (zenzai), vegetable juice, Japanese tea, oolong tea, black tea, coffee, cocoa, dried fish, fish cake products, canned fish, broiled fish, boiled fish, salted fish guts, salted fish roe, smoked products, pickled products, milk, yogurt, cheese; dip for roasted meat, grilled chicken, beef guts cooked in pot, ham, sausage, hamburger, eggs fried in layers, steamed egg custard, pot-steamed hotchpotch, miso soup, fermented soybeans (natto), pickled vegetable, sake, sparkling liquor, whiskey, distilled spirit (shochu) or wine.

9. A method for enhancing the unique flavor of a food by adding said flavor-enhancing agent in accordance with claim 1 to said food.
